(19) United States
(12) Patent Application Publication
(10) Pub. No.: US 2023/0325268 A1
(43) Pub. Date: Oct. 12, 2023

(54) METHOD AND DEVICE FOR AUTOMATICALLY DETERMINING A CURRENT CONDITION OF A SYSTEM IN OPERATION

(71) Applicant: Krones AG, Neutraubling (DE)

(72) Inventor: Christian Vogelsang, Kelheim (DE)

(21) Appl. No.: 18/193,167

(22) Filed: Mar. 30, 2023

(30) Foreign Application Priority Data
Apr. 8, 2022 (DE) 102022108584.8

(51) Int. Cl. G06F 11/07

(52) U.S. Cl. CPC G06F 11/0769; G06F 11/0721

(57) ABSTRACT

A method for automatically determining a current condition of a system in operation includes acquiring first data relating to one or more faults in the system during a process, acquiring second data relating to a process time in the system during the process, acquiring third data relating to media and energy consumption in the system during the process, and determining a process indicator number based on the first, second, and third data. A device for automatically determining a current condition of a system in operation is configured to carry out the method.

### CROSS-REFERENCE TO RELATED APPLICATION(S) AND CLAIM OF PRIORITY

This application claims priority to German Patent Application No. 102022108584.8, filed Apr. 8, 2022, the disclosure of which is incorporated herein by reference.

### TECHNICAL FIELD

The invention relates to methods for automatically determining a current condition of a system in operation and automatically determining a current condition of a system in operation from a process engineering perspective.

### BACKGROUND

Conventional system diagnostics does not allow for a fast and simple statement about the current condition of a system in operation.

Intelligent condition monitoring and fault diagnosis systems are known. EP 2 998 894 B1, for example, discloses a system for condition monitoring and fault diagnosis of a machine with a control system, with a data collection function for acquiring time histories of selected variables, with a preprocessing function for individually calculating specified characteristics of each of the time histories using predetermined dynamic models of the machine, with an analysis function for evaluating the specified characteristics or for generating hypotheses of a condition of machine components, and with an reasoning function for determining the condition of the machine components from the hypotheses.

### SUMMARY

This disclosure provides a method and a device with which an analysis of a procedural process of a system is possible.

A method for automatically determining a current condition of a system in operation includes acquiring first data relating to one or more faults in the system during a process, acquiring second data relating to a process time in the system during the process, acquiring third data relating to media and energy consumption in the system during the process, and determining a process indicator number based on first, second, and third data.

The system can comprise one or more machines or machine modules.

The first, second and third data can comprise data from the entire system or data from individual machines or machine modules.

The current condition of the system that is in operation can indicate whether the system fully meets a requirement specified (e.g., the process indicator number equals 100), or whether the requirement specified is met only in part (e.g., 0<process indicator number <100) or not at all (e.g., process indicator number equals 0).

Systems can be compared, for example, in order to identify an efficiency of technical changes, for example, as a result of changes in the series-production status.

Acquiring the first, second and third data can take place continuously during the operation of the system or during a time interval, for example, a day or an hour or the like. The process indicator number determined can then have a corresponding time dependency.

Acquiring the first, second and third data can be done with sensors of the system provided for this purpose, for example, an acquisition function can be provided. For example, the sensor system can transmit this data for determining the process indicator number so that the determination can be carried out by way of a determination function provided.

The process indicator number can result from the sum of contributions from the first, second, and third data. For example, values for the process indicator number can range from 0 to 100, where the range limits can be included. The first data can contribute to the process indicator number in a range from 0 to 50, where the range limits can be included. The second data can contribute to the process indicator number in a range from 0 to 30, where the range limits can be included. The third data can contribute to the process indicator number in a range from 0 to 20, where the range limits can be included.

The process indicator number can indicate a quality of the system. The process indicator number can represent an objective analysis of fault frequencies and changes in certain process times.

In this disclosure, the designation “first”, “second”, and “third” merely serves to distinguish between features having the same name and otherwise has no further restrictive meaning.

In addition, the method can comprise using the determined process indicator number to decide whether to initiate maintenance, troubleshooting and/or cleaning, service and/or repair work.

A decision can be made by comparing the determined process indicator number to a process indicator number specified (reference process indicator number). The comparison and the decision can be made automatically by way of a control device. If the determined process indicator number is, for example, less than or equal to the process indicator number specified, then maintenance, troubleshooting and/or cleaning, service and/or repair work can be carried out. If the determined process indicator number is, for example, greater than the process indicator number specified, then maintenance, troubleshooting and/or cleaning, service and/or repair work are not required.

The determined process indicator number and the one specified can be made available to a control device or be stored in a memory of the control device or in a memory to which the control device has access, so that maintenance, troubleshooting and/or cleaning, service and/or repair work can be carried out by the control device.

In addition or as an alternative, the determined process indicator number and the one specified can be displayed on a screen or released from an alternative storage location (cloud) for further data processing. Maintenance, troubleshooting and/or cleaning, service and/or repair work can then also be initiated by a human operator instead of by the control device.

During the acquisition of the first data, the following can be acquired:
first faults in the system which lead to a process stoppage of the process;
second faults in the system which lead to an extension of the process in time; and/or
third faults in the system that do not result in any extension in time and in no process stoppage of the process.

Faults that can cause process stoppage can comprise a sterile region that is non-sterile or a pump running dry.

Faults that can lead to an extension of the process in time can comprise exceeding a heating time, nozzles being open to a reduced degree, laboratory sampling.

Faults that cannot lead to an extension in time or to a process stoppage can comprise overflow of the containers during the filling process.

The first, second, and third faults can be classified into a respective first class, second class, and third class. For example, different weighting can respectively be used in the first, the second, and the third class. For example, a maximum first weighting in the first, second, and third class can total 50% of the process indicator number. With a maximum process indicator number of 100, weighting in the first class can amount to, for example, 30, in the second class, for example, to 15, and in the third class, for example, to 5.

During the acquisition of the second data, the following can be acquired: the process time of all process steps that can be used for starting up (ramp-up), producing and shutting down (ramp-down) a system, such as cleaning-in-place (CIP), sterilization-in-place (SIP), a rinsing or cooling step, a production interruption or a shutdown procedure (ramp-down).

For example, a maximum second weighting can total 30% of the process indicator number.

During the acquisition of the third data, a quantity of media or electrical energy used can be measured. For example, a maximum third weighting can total 20% of the process indicator number.

The media can comprise water, air, steam, chemicals such as lye, acid, surfactant, peracetic acid, and hydrogen peroxide. The energy refers to the electrical energy.

The process indicator number and/or the first, second, and third data can be stored, for example, for further analysis or the like.

An operating state of the system during the process can be stored. The operating state can comprise program steps of the system and/or the machines that it comprises and/or the machine modules that it comprises.

The first, the second, and/or the third fault can be analyzed. For example, events in the system that are related to one another in terms of time can be associated during the analysis. For example, an association to the environmental conditions of the system can be made during the analysis.

The events can comprise faults in the system and/or changes to the system. A time relation can mean that a first event occurred at a first point in time and causes a second event to occur at a second point in time. A maximum period of time can be specified for a time relation.

The environmental conditions can comprise the ambient temperature of the system (e.g., the hall temperature), the humidity, the air pressure, and the like.

A time profile of the process indicator number can be created. The time profile of the process indicator number can be saved. In further analyzes and/or comparisons, it can be viewed as the preceding course of the process indicator number over time. For example, the time profile of the process indicator number can be compared with a preceding time profile of the process indicator number.

The device for a determining automatically a current condition of a system in operation is configured to carry out a method as described above or further below.

The device can comprise an acquisition function for acquiring the first, second and/or third data.

The device can comprise a determination function for determining the process indicator number based on the first, second, and third data and/or for creating the time profile of the process indicator number.

The device can comprise an analysis function for analyzing the first, the second, and/or the third fault.

### BRIEF DESCRIPTION OF THE DRAWINGS

The accompanying figures lead to a better understanding and are to illustrate aspects of the invention, where:

FIG. 1 illustrates a schematic block diagram for determining a process indicator number; and

FIG. 2 illustrates a time profile of a process indicator number.

### DETAILED DESCRIPTION

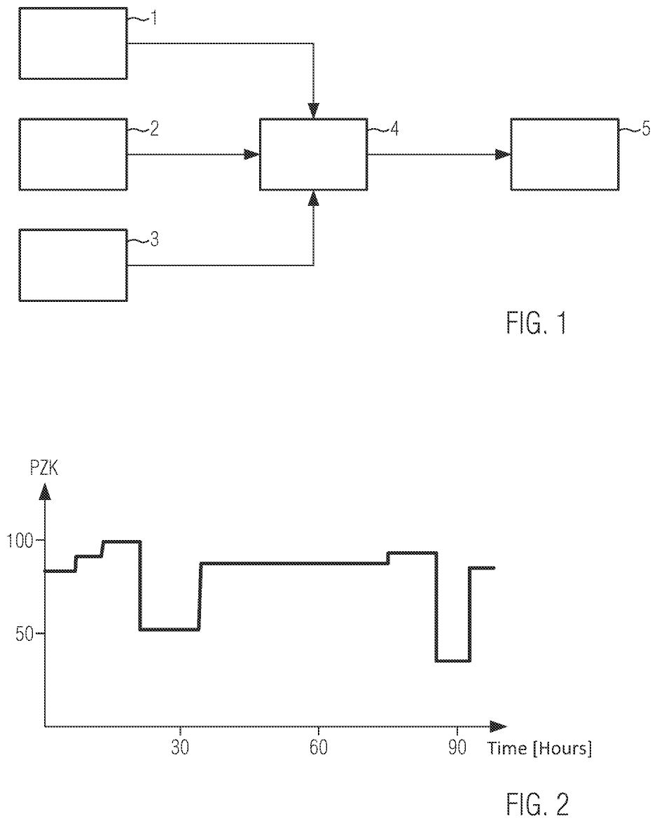

FIG. 1 shows a schematic block diagram for determining a process indicator number in a system. In block 1, first data relating to one or more faults in the system is acquired during a process. In block 2, second data relating to a process time in the system is acquired during the process. In block 3, third data relating to media consumption in the system is acquired during the process.

Based on this first, second, and third data, a process indicator number is determined in block 4. In block 5, the determined process indicator number is output, for example, as a function of time. For example, an objective analysis of fault frequencies and changes in certain process times can be illustrated using the determined process indicator number. For this purpose, the determined process indicator number can be compared with a preprocess indicator number specified.

For example, the determined process indicator number and the one specified can be made available to a control device or be stored in a memory of the control device or in a memory to which the control device has access so that maintenance, troubleshooting and/or cleaning, service and/or repair work can be carried out by the control device.

In addition or as an alternative, the process indicator number determined and the one specified can be displayed on a screen. Maintenance, troubleshooting and/or cleaning, service and/or repair work can then also be initiated by a human operator instead of by the control device.

FIG. 2 shows a time profile of process indicator number PZK, where the time is illustrated in hours. In the exemplary illustration, the process indicator number increases incrementally from a value of around 80 to 100, after which it decreases to around 50 and remains there for some time, around 15 hours. This is followed by an increase to about 80 which remains for about 40 hours. This is followed by an increase to around 90, which is maintained for about 10 hours before dropping to 30 and then increasing to 75.

1. A method for automatically determining a current condition of a system in operation, the method comprising:
acquiring first data relating to one or more faults in the system during a process;
acquiring second data relating to a process time in the system during the process;
acquiring third data relating to media and energy consumption in the system during the process; and
determining a process indicator number based on the first data, the second data, and the third data.

2. The method of claim 1, further comprising using the determined process indicator number to determine whether to initiate at least one of maintenance, troubleshooting, cleaning, service, and repair work.

3. The method of claim 1, wherein acquiring the first data includes acquiring at least one of the following:
first faults in the system which lead to a process stoppage of the process;
second faults in the system which lead to an extension of the process in time; and
third faults in the system that do not lead to any extension in time and to no process stoppage of the process.

4. The method of claim 3, further comprising classifying the first faults, the second faults, and the third faults into a respective first class, second class, and third class,
wherein different weighting is respectively used in the first class, the second class, and the third class, and
wherein a maximum first weighting in the first, second, and third classes totals 50% of the process indicator number.

5. The method of claim 4, wherein acquiring the second data includes acquiring:
a process time of at least one of:
a ramp-up of the system;
a cleaning-in-place (CIP);
a sterilization-in-place (SIP);
a rinsing step;
a cooling step;
a production interruption; and
a ramp-down of the system,
wherein a maximum second weighting totals 30% of the process indicator number.

6. The method of claim 5, further comprising measuring, during the acquisition of the third data, a quantity of media or electrical energy used, wherein a maximum third weighting amounts to 20% of the process indicator number.

7. The method of claim 1, further comprising storing at least one of:
the process indicator number; and
the first, second, and third data.

8. The method of claim 1, further comprising storing an operating state of the system.

9. The method of claim 3, further comprising analyzing the first faults, the second faults, and/or the third faults including:
associating, during the analysis, events in the system that are related to one another in terms of time; and
making, during the analysis, an association to environmental conditions of the system.

10. The method of claim 1, further comprising:
creating a time profile of the process indicator number; and
comparing the time profile of the process indicator number with a preceding time profile of the process indicator number.

11. A device for automatically determining a current condition of a system in operation, wherein the device is configured to:
acquire first data relating to one or more faults in the system during a process;
acquire second data relating to a process time in the system during the process;
acquire third data relating to media and energy consumption in the system during the process; and
determine a process indicator number based on the first data, the second data, and the third data.

12. The device according to claim 11, wherein the device is further configured to perform an acquisition function to acquire the first data, the second data, and/or the third data.

13. The device according to claim 12, wherein the device is further configured to perform a determination function to determine the process indicator number based on the first data, the second data, and the third data, and/or to create a time profile of the process indicator number.

14. (canceled)

15. The device of claim 11, wherein, to acquire the first data, the device is further configured to acquire at least one of the following:
first faults in the system which lead to a process stoppage of the process;
second faults in the system which lead to an extension of the process in time; and
third faults in the system that do not lead to any extension in time and to no process stoppage of the process.

16. The device of claim 15, wherein the device is further configured to perform an analysis function for analyzing at least one of the first faults, the second faults, and the third faults.

17. The device of claim 16, wherein the device is further configured to classify the first faults, the second faults, and the third faults into a respective first class, second class, and third class, wherein different weighting is respectively used in the first class, the second class, and the third class, and wherein a maximum first weighting in the first, second, and third classes totals 50% of the process indicator number.

18. The method of claim 3, further comprising classifying the first faults, the second faults, and the third faults into a respective first class, second class, and third class, wherein different weighting is respectively used in the first class, the second class, and the third class.

19. The method of claim 18, wherein a maximum weighting in the first, second, and third classes totals 50% of the process indicator number.

20. The method of claim 18, wherein acquiring the second data includes acquiring a process time of at least one of:
a ramp-up of the system;
a cleaning-in-place (CIP);
a sterilization-in-place (SIP);
a rinsing step;
a cooling step;
a production interruption; and
a ramp-down of the system,
wherein a maximum weighting totals 30% of the process indicator number.

21. The method of claim 18, further comprising measuring, during the acquisition of the third data, a quantity of media or electrical energy used, wherein a maximum weighting amounts to 20% of the process indicator number.
